(19) United States
(12) Patent Application Publication
(10) Pub. No.: US 2019/0188284 A1
(43) Pub. Date: Jun. 20, 2019

(54) RELOCATION COMMUNITY RECOMMENDATION SYSTEM AND METHOD WITH PAYMENT TRANSACTION DATA AGGREGATION AND DEMOGRAPHIC PROFILING

(71) Applicant: MASTERCARD INTERNATIONAL INCORPORATED, Purchase, NY (US)

(72) Inventor: Manoneet Kohli, White Plains, NY (US)

(21) Appl. No.: 15/849,257

(22) Filed: Dec. 20, 2017

(51) Int. Cl. G06F 17/30; G06Q 50/16; G06Q 20/04; H04L 29/08

(52) U.S. Cl. CPC G06F 17/30241; H04L 67/306; G06Q 20/04; G06Q 50/16

(57) ABSTRACT

An electronic computing system and method for recommending a relocation community includes a computing device configured to build, based on payment transaction data relating to a plurality of persons residing in a plurality of communities, a demographic profile for each of the plurality of persons. The computing device retrieves and compares demographic profiles of persons residing within a geographic boundary input by a requestor to identify persons having matching profiles to the requestor, determines at least one recommended relocation community within the geographic boundary, and communicates the at least one recommended relocation community to the requestor.

### BACKGROUND

This disclosure relates generally to a payment transaction data system and, more specifically, to payment transaction data aggregation and analysis systems and methods for providing a community recommendation to a cardholder who is relocating from a first community to a second community in different geographic areas.

Merchant recommendation systems are known that analyze payment card transaction data of an individual in a first geographic area, and based on the analyzed transaction data can recommend merchants to the individual in a second geographic location. Such merchant recommendations can be convenient to a traveling cardholder. Once the cardholder arrives at a destination, the recommendation system can make the cardholder aware of area merchants offering products or services of interest to the cardholder. Known systems of this type depend on the cardholder's choice of location in order to operate. In other words, the cardholder's chosen location is an input to the system, and merchant recommendations in the input location are the system outputs. As such, merchant recommendations systems of this type are of no practical benefit to a cardholder who desires help in making a decision regarding the chosen location itself.

For various reasons that may be job-related, school-related, or family-related, persons often decide to move residence or relocate from one community in a first geographic location to another community in a second geographic location. Once the general decision to relocate is made, a person is faced with a number of possible communities in which to relocate within a desired geographic region or geographic area, either generally or specifically.

For example, a person may decide to move from suburban St. Louis, Mo. to the state of New York generally and as such may choose to relocate in any of a large number of communities in the state. As another example, a person may decide to move from suburban St. Louis Mo. to a more specific area of the state of New York (e.g., the Northern portion of New York State) and as such may choose to relocate in any of the large number of northern communities in the New York State. As still another example, a person may decide to move from suburban St. Louis, Mo. to a specific city in New York State (e.g., Albany). In each case, a number of different communities (e.g., different residential areas, subdivisions, municipalities, zip codes, etc.) are available for the person to potentially relocate, and accordingly a decision must be made to choose one of them. In many cases, persons faced with such a decision may know little to nothing about the available community choices to consider and may have a limited amount of time or resources to fully consider their decision of where to relocate. This can lead to sub-optimal choices and sometimes regret in the choice to relocate to a given community.

While much information is typically available from moving companies, real estate agents, and communities themselves that persons may study to try to make good choices in selecting a relocation community, conventionally available information tends to be of limited use for a person to truly know how satisfied they would be to live in any given community. Much of the data available is intended to objectively allow some comparison of different communities in general terms such as basic resident demographics (e.g., average age of residents, average income, and average family size), dwelling information (e.g., average home prices, average apartment rent), area school information (e.g., number of students, teacher to student ratios, average test scores), and state and local tax information. Local communities may additionally provide promotional materials including area attractions, entertainment and leisure/lifestyle information that is not as easily compared from one community to another. Collecting and analyzing this information over a large number of communities is time intensive and impractical to many persons. Obtaining reliable and up-to-date data in a consistent format to easily compare communities is not easily accomplished, if it can be accomplished at all, by the typical user.

A person's satisfaction in a community after relocating often depends on many subjective factors that are not evident from available materials and objective data points. Practically speaking, it is very difficult to compare a person's life in an existing community to life in a prospective community should the person choose to move there before the move is actually made. Not surprisingly, after an initial relocation move to a community in the area, persons are known to subsequently move to a more desirable area after becoming more acclimated with their community choices in the area. The burden and expense of moving is typically high, however, and many persons would prefer to avoid unnecessary moves if possible.

Efficient electronic tools, systems and methods are desired to more easily assess possible relocation communities for relocating persons to improve their likelihood of lifestyle satisfaction and avoid having to make a subsequent move to another community after relocating. Electronic tools, systems and methods that can effectively recommend communities that a cardholder may relocate to and live in with an improved likelihood of satisfaction would be desired even more.

### BRIEF DESCRIPTION

In one aspect, the disclosure provides an electronic computing system for recommending a relocation community, the system includes at least one host computing device comprising at least one processor in communication with a memory device, wherein the at least one host computing device is configured to accept payment transaction data relating to a plurality of persons residing in a plurality of communities, and based on the accepted payment transaction data, build a demographic profile for each of the plurality of persons. The at least one host computing device is also configured to accept a request for a relocation community recommendation from the requestor, the requestor being one of the plurality of persons having a demographic profile and the request for a relocation community recommendation including a geographic boundary. In response to the accepted request for a relocation community the at least one host computing device is configured to: retrieve demographic profiles of persons residing within the geographic boundary; compare the demographic profile of the requestor to the retrieved demographic profiles of the persons residing within the geographic boundary to identify persons having matching profiles to the requestor; determine at least one recommended relocation community within the geographic boundary based on the identified persons having matching profiles to the requestor; and communicate the at least one recommended relocation community to the requestor.

In another aspect, the disclosure provides a computer-implemented method for electronically recommending a relocation community. The method is implemented by at least one host computing device including at least one processor in communication with a memory device. The method includes accepting payment transaction data by the host computing device, the payment transaction data relating to a plurality of persons including a requestor with the plurality of persons residing in a plurality of communities, and based on the accepted payment transaction data, building a demographic profile for each of the plurality of persons. The method also includes accepting, by the host computing device, a request for a relocation community recommendation from the requestor, the request for a relocation community recommendation including a geographic boundary. In response to the accepted request, the computer-implemented method includes retrieving demographic profiles of persons residing within the geographic boundary, comparing the demographic profile of the requestor to demographic profiles of the persons residing within the geographic boundary to identify persons having matching profiles to the requestor, determining at least one recommended relocation community within the geographic boundary for the identified persons having matching profiles to the requestor, and communicating the at least one recommended relocation community to the requestor.

In another aspect, the disclosure provides a non-transitory computer readable medium that includes computer executable instructions for electronically recommending a relocation community, wherein when executed by at least one host computing device having at least one processor in communication with a memory device, the computer executable instructions cause the at least one host computing device to accept payment transaction data relating to a plurality of persons including a requestor with the plurality of persons residing in a plurality of communities, and based on the accepted payment transaction data, build a demographic profile for each of the plurality of persons. The computer executable instructions cause the at least one host computing device to accept a request for a relocation community recommendation from the requestor, the request for a relocation community recommendation including a geographic boundary. In response to the accepted request, the computer executable instructions cause the at least one host computing device to retrieve demographic profiles of persons residing within the geographic boundary, compare the demographic profile of the requestor to demographic profiles of the persons residing within the geographic boundary to identify persons having matching profiles to the requestor, determine at least one recommended relocation community within the geographic boundary for the identified persons having matching profiles to the requestor, and communicate the at least one recommended relocation community to the requestor.

### BRIEF DESCRIPTION OF THE DRAWINGS

FIG. 1 is a schematic diagram illustrating an exemplary relocation community recommendation system in communication with a multi-party payment network system for processing payment card transactions.

FIG. 2 is a geographic representation of a relocation community recommendation for the system shown in FIG. 1.

FIG. 3 is an expanded schematic diagram illustrating an exemplary computer system of the disclosure including a recommendation computing device that operates upon a geographic representation such as that shown in FIG. 2.

FIG. 4 illustrates an example configuration of a user device for the system shown in FIGS. 1 and 3.

FIG. 5 is a schematic diagram of an example server computing device that maybe used with the computer system shown in FIG. 3.

FIG. 6 shows an example configuration of a user account database within a computing device, along with other related computing components, that may be used to create, organize, and monitor a plurality of user data associated with a user.

FIG. 7 shows an exemplary process of a relocation community recommendation for the system shown in FIG. 3.

### DETAILED DESCRIPTION OF THE DISCLOSURE

The following detailed description illustrates embodiments of the disclosure by way of example and not by way of limitation. The description enables one skilled in the art to make and use the disclosure, describes several embodiments, adaptations, variations, alternatives, and uses of the disclosure, including what is presently believed to be the best mode of carrying out the disclosure.

The systems and methods of the disclosure electronically evaluate a person's lifestyle via analyzing financial payment transactions of persons in different communities in different geographic areas and comparing them to one another. Financial payment data is collected and aggregated via a digital wallet service and is analyzed to provide demographic spending profiles of each person in various different communities in different geographic areas. When a person decides to relocate, he or she may request a relocation community recommendation from the system and in doing so identify a geographic boundary (e.g., New York State, northern New York State, or the greater Albany metropolitan area including Albany suburbs) as an input for the system to selected and recommend a community within the geographic boundary for the user to relocate with a likelihood of satisfaction. The requestor may also draw a geographic boundary on a map that can be processed by the system as an input to making a relocation community recommendation.

Once a request for relocation community recommendation is received, the system and method of the disclosure retrieves the requesting person's aggregated demographic spending profile and compares that person's profile to those residing within the geographic boundary. By matching the relocating person's profile to those of others having similar aggregated demographic spending profiles in the community, the system recommends a specific community or communities within the geographic boundary to the requestor. The recommended communities, by virtue of matching aggregated demographic spending profiles, offer similar lifestyles to the requestor as he or she enjoys prior to relocating. The requestor may then decide to move to a recommended relocation community with an improved likelihood of satisfaction.

The systems and methods of the disclosure are premised on the assumption that a relocating person desires a similar lifestyle to that experienced in his or her present community in the next community that the person may choose to relocate. As such, a person that has a gym membership in his or her present community is likely to desire and enjoy a gym membership in a relocation community, and as such this can be a consideration in choosing a relocation community. Likewise, a person that is paying private school tuition for a child in his or her present community is likely to desire a private school education in the relocation community, and as such an availability of private schools should be a consideration in deciding amongst various different possible relocation communities. Many similar factors are also worth considering, such as grocery expenditures versus restaurant expenditures, entertainment expenditures (by amount and type), expenditures for gasoline or other necessities, and discretionary spending items such as clothing, coffee or drinks, snacks. All these and more are typically evident from financial spending, although the typical person may lack knowledge or resources to fully harness this information in making a decision where to live.

Financial transaction data can be aggregated and analyzed to build demographic spending profiles or patterns that can be compared to profiles of other persons in different communities as a predictive indicator of a relocating person's satisfaction (or not) of moving to a particular community. For instance, a person who rarely eats out may place a greater value on accessibility of a quality grocery store when evaluating a relocation community than a person who eats out most of the time. Likewise, a person who eats out most of the time would place a higher value on the quality of local restaurants when evaluating a relocation community than the person who rarely eats out. In this aspect, the demographic profile may be analyzed with consideration of relative amounts and proportions of transaction amounts at grocery stores versus restaurants, and can effectively predict a person's community satisfaction in any given relocation community. Similar analysis and comparisons can be made across a number or areas to improve the satisfaction even more.

For example, a demographic profile generated by the system and method of the disclosure for person A may show that person A in his or her present community A shops at a COSTCO® wholesale store on a regular basis, regularly makes a private school tuition payment in a regular amount, buys gasoline about every eight days, eats out twice a week, grocery shops on a weekly basis, has a gym membership, and visits a movie theater about once a month. Much information is gleaned from this data that can be used to recommend a prospective community for person A's relocation. For instance, it can be inferred that person A finds COSTCO® wholesale stores to be convenient, that a private school education is preferable, that shorter commutes are preferred, that relatively speaking restaurants are not that important to person A, that person A likes to exercise, and that person A enjoys movies. In view of this, a community that has no locally convenient COSTCO® wholesale store, no local private schools, an abundance of restaurants, requires long commutes, and has no local gym is probably not a place that, relatively speaking, person A would like to live.

If the system and method of the disclosure can locate another person, however, namely person B, who has a similar profile to person A in these aspects (or preferably a group of people having similar profiles to person A) that live in another community (community B), then person A may be quite happy living in community B and the system may therefore recommend community B to person A. Person A and person B may live far away from one another, but enjoy a similar lifestyle in the mentioned aspects. As such, if person A is a current resident of St. Louis, Mo. that is looking to relocate to Albany, N.Y. (e.g. community B), then community B (including person B as identified by the system and method of the disclosure) may be a good match for person A and the system can accordingly recommend that person A move to community B in the Albany area. Person A can likely live a similar lifestyle in community B that person A was living in Missouri and likely would be happy living in community B. When a group of persons in community B are found to have similar profiles to person A, the recommendation of community B can be made with confidence.

Geo-location services may be utilized by the system to build demographic profiles of system users as transactions are made using digital wallet services, and the system may determine relative residential locations of persons and communities for the relocation community recommendation services of the system. As such, the system and method of the disclosure may detect a locus of transactions within a geofenced area for each system user, and the system and method may use the geofenced area as a proxy for a residence of a profiled person and any associated relocation community recommendation. The greater the concentration of profiled users in the geofenced area with matching or closely matching profiles to a relocating person, the stronger the recommendation to user A to move to that community becomes. For instance, a geofenced area having 60 users whose profiles closely match the profile of user A is presumed to be more desirable to user A than another geofenced area of similar size having 10 users whose profiles closely match the profile of user A.

The system in building the demographic profiles may also infer the residence of profiled persons and associated communities of the respective users profiled by deducing patterns in the transaction data analyzed for each user over a period of time. For instance, monthly spending patterns or average monthly spending can be utilized to deduce lifestyle attributes for consideration by the system. As one example, where a person most often buys gasoline is likely to be close to home and how often they buy gas is an indicator of their commuting preferences. Likewise, where a person most often buys groceries is also likely to be close to home, and how often the person buys groceries is an indicator of their relative preference of cooking at home versus eating out. Based on these kinds of indicators, the system can build a demographic spending profile and assign a community to each profiled person for purposes of the system.

In some cases, accounts and digital wallet services may be provided by a bank that has an actual residential address for a system user, and as such actual addresses can be used to determine residences and associated communities of profiled persons for the purposes of the relocation community recommendation services. Where the actual residential address of a profiled person is unknown, the system can infer a location of a profiled user based on the transaction data. Such inferences can be made by assigning a profiled person's residence to correspond to the city of address for the gas station or grocery store most often visited, via a locus of transactions in the same general area, or in another manner specific to the system. The system and method of the disclosure may also utilize shipping addresses for purchased items to infer a residence of system users in order for relocation community recommendation services.

The recommended relocation community may be identified specifically by metropolitan name (e.g., Saratoga Springs, N.Y., a suburb of Albany) or generally via a county (e.g., Albany County, N.Y.) or by zip code, or in another manner such as providing a map with a relocation area boundary to the requestor. The specificity of a relocation community location may vary depending on the specification of the request made. For example, if the requestor seeks a recommendation for a relocation community in New York State, a recommendation to relocate in Albany County, N.Y. or a zip code that includes Albany, N.Y. would be appropriate and likely helpful to the requestor, whereas if the requestor seeks a recommendation for a relocation community in the greater Albany area, a recommendation to relocate in Saratoga Springs, N.Y. would be more appropriate and helpful to the requestor. If a map with a relocation area is returned to the requestor, the relocation area may include multiple zip codes, more than one country, more than town or municipality, and more than one subdivision that likewise may be helpful to a requestor.

As the number of user profiles are increased in any community, the system may more effectively match (or fail to match) user profiles in that community with user A who wishes to relocate. To the extent that a locus of profiled persons can be found in the same community that closely match the profile of a relocating person in the desired aspects, the confidence level of the community recommendation may increase.

In one aspect, the system and method of the disclosure receives payment card transaction data that may be received and analyzed to create and build demographic profiles for enrolled cardholders. The cardholder data can easily be categorized and analyzed to determine demographic spending profiles including relative amounts of spending in different areas (e.g., across different types of merchants and categories of merchants) and compare enrolled and profiled cardholders in different communities to one another in order to make a relocation community recommendation with an improved likelihood of satisfaction for a relocating user of the system.

In another aspect, the system and method of the disclosure may, in addition to digital wallet transaction data, receive automatic withdrawal transaction data from a user's checking or savings account. The automatic withdrawal data may be analyzed in combination with digital wallet data to create and build demographic profiles for enrolled system users. The automatic withdrawal data can be categorized by merchant and analyzed in combination with digital wallet data to determine relative amounts of spending in different areas and compare enrolled cardholders in different communities in order to make a community recommendation to a relocating cardholder in order to compare community satisfaction likelihood for a relocating system user. As such, if private school is tuition payment is made by automatic withdrawal rather than a digital wallet payment, the private school tuition can still be detected and accounted for in a relocation community recommendation.

In another aspect, the system and method of the disclosure receives payment check transaction data from a user's bank account that may be analyzed to create and build demographic profiles for enrolled users. The payment check transaction data may be categorized and analyzed to determine relative amounts of spending in different areas and compare enrolled cardholders in different communities in order to make a community recommendation to a relocating cardholder in order to compare community satisfaction likelihood for a relocating system user. As such, if private school is tuition payment is made by check rather than a digital wallet payment or an automatic withdrawal payment, the private school tuition can still be detected and accounted for in a relocation community recommendation.

The system and method of the disclosure may additionally generate informational reports for review by a requestor. Reports may be generated for review by the requestor to review his or her own profile information and/or reports may be generated for the community being recommended for relocation. A list of recommended relocation communities may be provided in response to a request, and the list of recommended communities may be ranked according to weighted factors that may be selected by the requestor or automatically applied by the system. As such, the system and method may provide a choice of recommended relocation communities with supporting detail that they requestor may consider in making his or her decision.

In one embodiment, the disclosure provides an electronic computing system for recommending a relocation community, the system includes at least one host computing device comprising at least one processor in communication with a memory device, wherein the at least one host computing device is configured to accept payment transaction data relating to a plurality of persons residing in a plurality of communities, and based on the accepted payment transaction data, build a demographic profile for each of the plurality of persons. The at least one host computing device is also configured to accept a request for a relocation community recommendation from the requestor, the requestor being one of the plurality of persons having a demographic profile and the request for a relocation community recommendation including a geographic boundary. In response to the accepted request for a relocation community the at least one host computing device is configured to: retrieve demographic profiles of persons residing within the geographic boundary; compare the demographic profile of the requestor to the retrieved demographic profiles of the persons residing within the geographic boundary to identify persons having matching profiles to the requestor; determine at least one recommended relocation community within the geographic boundary based on the identified persons having matching profiles to the requestor; and communicate the at least one recommended relocation community to the requestor.

Further, the at least one host computing device is in communication with a multi-party payment processing network for processing payment card transactions, with the at least one host computing device further configured to receive payment card transaction data from the multi-party payment processing network, and build the demographic profile for each of the plurality of persons based on the payment card transaction data.

The at least one host computing device may also be in communication with an automated clearing house payment system, with the at least one host computing device further configured to receive automated clearing house transaction data from the automated clearing house system, and build the demographic profile for each of the plurality of persons based on a combination of the payment card transaction data the automated clearing house transaction data.

The at least one host computing device may likewise be in communication with a check payment system, with the at least one host computing device further configured to receive check payment transaction data from the check payment system, and build the demographic profile for each of the plurality of persons based on a combination of the payment card transaction data and the check payment transaction data.

The at least one host computing device may also be in communication with a requestor device, the requestor device including a digital wallet service. The at least one host computing device is configured to infer a residence for at least some of the plurality of persons based on the payment transaction data. The at least one host computing device may be configured to infer a residence for at least some of the plurality of persons based on a locus of a plurality of payment transactions. The at least one host computing device may be configured to infer a residence for at least some of the plurality of persons based on merchant type and location for a plurality of payment transactions.

The at least one host computing device is configured to build a demographic profile for each of the plurality of persons based on transactions with a plurality of merchants of a different type and relative transaction amounts with each merchant type as indicated by the transaction data over a defined period. The at least one host computing device may be configured to build a demographic profile for each of the plurality of persons based on monthly proportional spending across a plurality of different types of merchants.

The at least one host computing device may also configured to generate a report of the requestor's demographic profile for review by the requestor. The at least one host computing device may likewise be configured to generate a report of the at least one recommended relocation community for review by the requestor. The at least one host computing device may be configured to generate a ranked list of recommended relocation communities, and may be configured to generate a report for a selected one of the ranked list of recommended relocation communities.

In another embodiment, the disclosure provides a computer-implemented method for electronically recommending a relocation community. The method is implemented by at least one host computing device including at least one processor in communication with a memory device. The method includes accepting payment transaction data by the host computing device, the payment transaction data relating to a plurality of persons including a requestor with the plurality of persons residing in a plurality of communities, and based on the accepted payment transaction data, building a demographic profile for each of the plurality of persons. The method also includes accepting, by the host computing device, a request for a relocation community recommendation from the requestor, the request for a relocation community recommendation including a geographic boundary. In response to the accepted request, the computer-implemented method includes retrieving demographic profiles of persons residing within the geographic boundary, comparing the demographic profile of the requestor to demographic profiles of the persons residing within the geographic boundary to identify persons having matching profiles to the requestor, determining at least one recommended relocation community within the geographic boundary for the identified persons having matching profiles to the requestor, and communicating the at least one recommended relocation community to the requestor.

The at least one host computing device may be in communication with a multi-party payment processing network for processing payment card transactions, and the computer-implemented method may further include receiving payment card transaction data from the multi-party payment processing network, and building the demographic profile for each of the plurality of persons based on the payment card transaction data.

The at least one host computing device may also be in communication with an automated clearing house system, with the computer-implemented method further including receiving automated clearing house transaction data from the automated clearing house system, and building the demographic profile for each of the plurality of persons based on a combination of the payment card transaction data the automated clearing house transaction data.

The at least one host computing device may likewise be in communication with a check payment system, and the computer-implemented method may further include receiving check payment transaction data from the check payment system, and building the demographic profile for each of the plurality of persons based on a combination of the payment card transaction data and the check payment transaction data.

The at least one host computing device may be in communication with a requestor device, the requestor device including a digital wallet service, and the computer-implemented method including receiving transaction data from the digital wallet service.

The method may also include inferring a residence for at least some of the plurality of persons based on the payment transaction data. Inferring a residence for at least some of the plurality of persons may include inferring a residence based on a locus of a plurality of payment transactions. Inferring a residence for at least some of the plurality of persons may also include inferring a residence based on merchant types and locations for a plurality of payment transactions.

Building a demographic profile for each of the plurality of persons may include building a demographic profile based on merchant type and relative transaction amounts as indicated by the transaction data over a defined period. Building a demographic profile for each of the plurality of persons may also include building a demographic profile based on monthly spending across a plurality of different types of merchants.

In another embodiment the disclosure provides a non-transitory computer readable medium that includes computer executable instructions for electronically recommending a relocation community, wherein when executed by at least one host computing device having at least one processor in communication with a memory device, the computer executable instructions cause the at least one host computing device to accept payment transaction data relating to a plurality of persons including a requestor with the plurality of persons residing in a plurality of communities, and based on the accepted payment transaction data, build a demographic profile for each of the plurality of persons. The computer executable instructions cause the at least one host computing device to accept a request for a relocation community recommendation from the requestor, the request for a relocation community recommendation including a geographic boundary. In response to the accepted request, the computer executable instructions cause the at least one host computing device to retrieve demographic profiles of persons residing within the geographic boundary, compare the demographic profile of the requestor to demographic profiles of the persons residing within the geographic boundary to identify persons having matching profiles to the requestor, determine at least one recommended relocation community within the geographic boundary for the identified persons having matching profiles to the requestor, and communicate the at least one recommended relocation community to the requestor.

The technical problems addressed by the computing systems and methods of the disclosure include at least one of: (i) inability to compare communities for relocation purposes with reliable data; (ii) inability to account for subjective user comparison of relocation communities in a relocation decision; (iii) inability to efficiently process payment transaction data for making a relocation community decision; (iv) inability to provide customized reports of a relocation community to a specific requestor; (v) inability to locate data to compare relocation communities to one another; (vi) inability to consider alternative forms of transaction payments in a decision to relocate to a given community; (vii) inability to comprehensively evaluate data reflective of lifestyle considerations across a population of persons to improve a likelihood of satisfaction with a relocation community; and (viii) avoidance of misleading data in making a relocation community decision that is unsatisfactory.

The payment card processing systems and methods of the disclosure may be implemented using computer programming or engineering techniques including computer software, firmware, hardware, or any combination or subset thereof, wherein the technical effects may be achieved by: (i) realizing direct comparison of different communities for relocation purposes with fresh and reliable data; (ii) incorporating subjective comparison of different communities with comparable data derived from users in different communities; (iii) efficient processing of payment transaction data for making an effective data-driven relocation community recommendation; (iv) producing customized reports of a relocation community to a specific requestor; (v) locating meaningful data to more effectively compare relocation communities to one another; (vi) efficiently and effectively incorporating alternative forms of transaction payments in a decision analysis to relocate to a given community; (vii) compile comprehensive evaluation data reflective of lifestyle considerations across a population of persons to improve a likelihood of satisfaction with a relocation community; and (viii) ensuring consideration of data to improve a likelihood of satisfaction in a relocation community.

The resulting technical benefits achieved by the payment card processing systems and methods include at least one of: (i) providing direct comparison of different communities for relocation purposes with fresh and reliable data; (ii) incorporate subjective comparison of different communities with comparable data derived from users in different communities; (iii) making an effective data-driven relocation community recommendation with improved efficiency and accuracy; (iv) customizing reports of a relocation community to meet the needs and preferences of a specific requestor; (v) effectively comparing relocation communities to one another with meaningful data for an individual requestor; (vi) incorporating alternative forms of transaction payments efficiently and effectively to inform a decision analysis to relocate to a given community with improved confidence; (vii) compiling comprehensive data reflective of lifestyle considerations across a population of persons to improve an evaluation of a relocation community and a likelihood of satisfaction with a relocation community; and (viii) improving a likelihood of satisfaction in a relocation community via consideration of data that is not otherwise available to an individual requestor.

In one embodiment, a computer program is provided, and the program is embodied on a computer-readable medium. In an example embodiment, the system may be executed on a single computer system, without requiring a connection to a server computer. In a further example embodiment, the system may be run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Technology, Inc. located in San Jose, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer-readable medium and utilizes a Structured Query Language (SQL) with a client user interface front-end for administration and a web interface for standard user input and reports. In another embodiment, the system is web enabled and is run on a business entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus, are not intended to limit in any way the definition and/or meaning of the term database. Examples of RDBMS's include, but are not limited to including, ORACLE® Database, MySQL, IBM® DB2, Microsoft® SQL Server, SYBASE®, and PostgreSQL. However, any database may be used that enables the system and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, any type of virtual card (e.g. virtual cards generated by issuers and/or third party processors via mobile bank or desktop apps) and/or any other device that may hold payment account information, such as mobile phones, Smartphones, personal digital assistants (PDAs), key fobs, digital wallets, and/or computers. Each type of transactions card can be used as a method of payment for performing a transaction. As used herein, the term “payment account” is used generally to refer to the underlying account with the transaction card. In addition, cardholder card account behavior can include but is not limited to purchases, management activities (e.g., balance checking), bill payments, achievement of targets (meeting account balance goals, paying bills on time), and/or product registrations (e.g., mobile application downloads).

As used herein, the term “transaction data” refers to data that includes at least a portion of a cardholder's account information (e.g., cardholder name, account identifier, credit line, security code, and/or expiration data) and at least a portion of purchase information (e.g., price, a type of item and/or service, SKU number, item/service description, purchase date, and/or confirmation number) supplied by a merchant from which the cardholder is making a purchase.

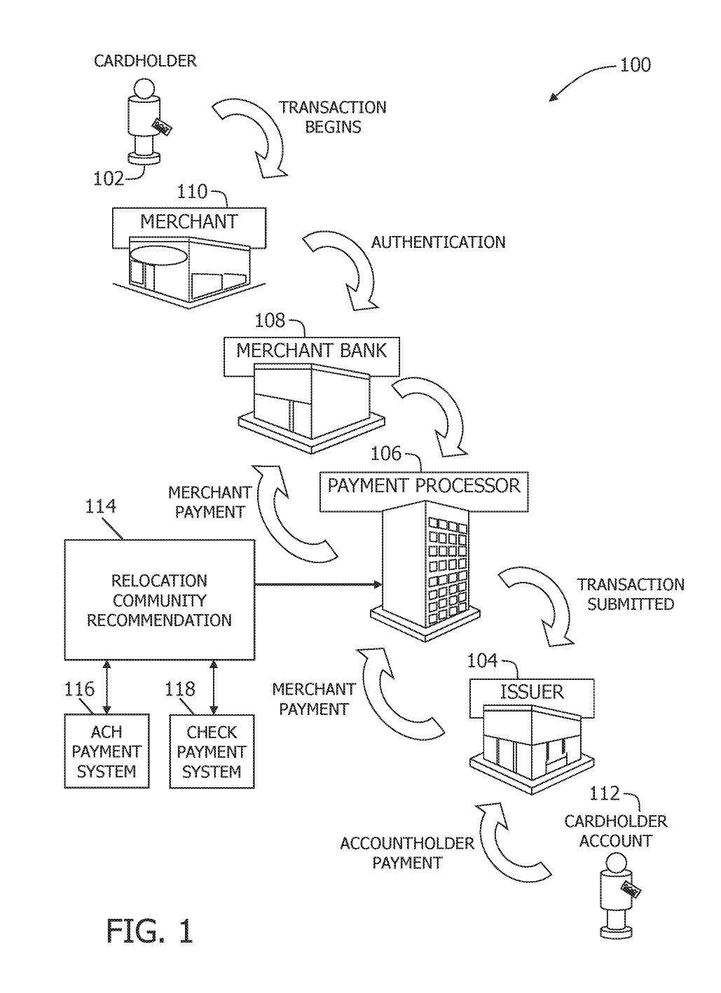

FIG. 1 is a schematic diagram illustrating an exemplary relocation community recommendation system 100 in communication with an exemplary multi-party payment card processing system and network for processing payment card transactions. The payment card processing system and network may in this example be a credit card payment network using the Mastercard® payment processor 106. Mastercard® payment processor 106 is a proprietary communications standard promulgated by Mastercard International Incorporated for the exchange of financial transaction data between financial institutions that are registered with Mastercard International Incorporated. (Mastercard is a registered trademark of Mastercard International Incorporated located in Purchase, N.Y.). Embodiments described herein may also relate to digital payment services such as MASTERPASS® by Mastercard or another digital wallet service for a mobile device such as a smartphone.

In the payment card processing network shown, a financial institution, such as an issuing bank 104, issues a payment card, such as a credit card account or a debit card account, to a cardholder 102, who uses the payment card to tender payment for a purchase from a merchant 110. To accept payment with the payment card, merchant 110 must normally establish an account with a financial institution that is part of the financial payment system. This financial institution is usually called the “merchant bank” or the “acquiring bank” or simply “acquirer”. When a cardholder 102 tenders payment for a purchase with a payment card (also known as a financial transaction card), merchant 110 requests authorization from merchant bank 108 for the amount of the purchase. The request may be performed over the telephone or via a website, but is oftentimes performed through the use of a point-of-sale terminal, which reads the cardholder's account information from the magnetic stripe on the payment card and communicates electronically with the transaction processing computers of merchant bank 108. Alternatively, merchant bank 108 may authorize a third party to perform transaction processing on its behalf. In this case, the point-of-sale terminal will be configured to communicate with the third party. Such a third party is usually called a “merchant processor” or an “acquiring processor.”

Using payment processor 106, the computers of merchant bank 108 or the merchant processor will communicate with the computers of issuing bank 104 to determine whether the cardholder's account is in good standing and whether the purchase is covered by the cardholder's available credit line or account balance. Based on these determinations, the request for authorization will be declined or accepted. If the request is accepted, the transaction is given a bank network reference number, such as the Banknet Reference Number used by Mastercard International Incorporated, an authorization code, and/or other transaction identifiers that may be used to identify the transaction.

The payment network may be configured to process authorization messages, such as ISO 8583 compliant messages and ISO 20022 compliant messages. As used herein, “ISO” refers to a series of standards approved by the International Organization for Standardization (ISO is a registered trademark of the International Organization for Standardization of Geneva, Switzerland). ISO 8583 compliant messages are defined by the ISO 8583 standard which governs financial transaction card originated messages and further defines acceptable message types, data elements, and code values associated with such financial transaction card originated messages. ISO 8583 compliant messages include a plurality of specified locations for data elements. ISO 20022 compliant messages are defined by the ISO 20022 standard. For example, ISO 20022 compliant messages may include acceptor to issuer card messages (ATICA).

During the authorization process of the payment card processing system, the clearing process is also taking place. During the clearing process, merchant bank 108 provides issuing bank 104 with information relating to the sale. No money is exchanged during clearing. Clearing (also referred to as “first presentment”) involves the exchange of data required to identify the cardholder's account 112 such as the account number, expiration date, billing address, amount of the sale, and/or other transaction identifiers that may be used to identify the transaction. Along with this data, banks in the United States also include a bank network reference number, such as the Banknet Reference Number used by Mastercard International Incorporated, which identifies that specific transaction. When the issuing bank 104 receives this data, it posts the amount of sale as a draw against the available credit in the cardholder account 112 and prepares to send payment to the merchant bank 108.

When a request for authorization is accepted, the available credit line or available account balance of cardholder's account 112 is decreased. Normally, a charge is not posted immediately to a cardholder's account 112 because bankcard associations, such as Mastercard International Incorporated, have promulgated rules that do not allow a merchant to charge, or “capture,” a transaction until goods are shipped or services are delivered. When a merchant 110 ships or delivers the goods or services, merchant 110 captures the transaction by, for example, appropriate data entry procedures on the point-of-sale terminal. If a cardholder 102 cancels a transaction before it is captured, a “void” is generated. If a cardholder 102 returns goods after the transaction has been captured, a “credit” is generated.

After a transaction is captured, the transaction is settled between merchant 110, merchant bank 108, and issuing bank 104. Settlement refers to the transfer of financial data or funds between the merchant's account, merchant bank 108, and issuing bank 104 related to the transaction. Usually, transactions are captured and accumulated into a “batch,” which is settled as a group.

Much transaction data captured by multi-party payment card processing systems is presently under-utilized to address issues presented by a relocating cardholder as described next. Accordingly, the system 100 includes a relocation community recommendation device 114 that receives and processes payment card transaction data from the payment card processing system and network in order to make a relocation community recommendation. The relocation community recommendation device 114 builds aggregated demographic spending profiles and/or compares cardholder demographic profiles by aggregating transaction data, and compares the demographic profiles of different cardholders in order to make a relocation community recommendation. Payment card transaction data may be considered by the relocation community recommendation device 114 as desired for multiple cardholders in the same community as in the examples described herein.

As shown in FIG. 1, the relocation community recommendation device 114 is also in communication with an ACH (automated clearing house) payment system or device 116 for making automated withdrawal payments from a user's checking or savings account, as well as a check payment system or device 118. As such, the relocation community recommendation device 114 may receive and analyze transaction data for alternative payment forms besides payment cards for improved accuracy in making a relocation community recommendation. The relocation community recommendation device 114 may accordingly consider payments to merchants that do not accept payment cards or payments that a user would rather not make with a payment card. Such payments may include, but are not limited to, private school tuition payments, payments for lawn care services, payments for home cleaning services, payments for pool maintenance services, etc. that are desirably considered in making a relocation community recommendation.

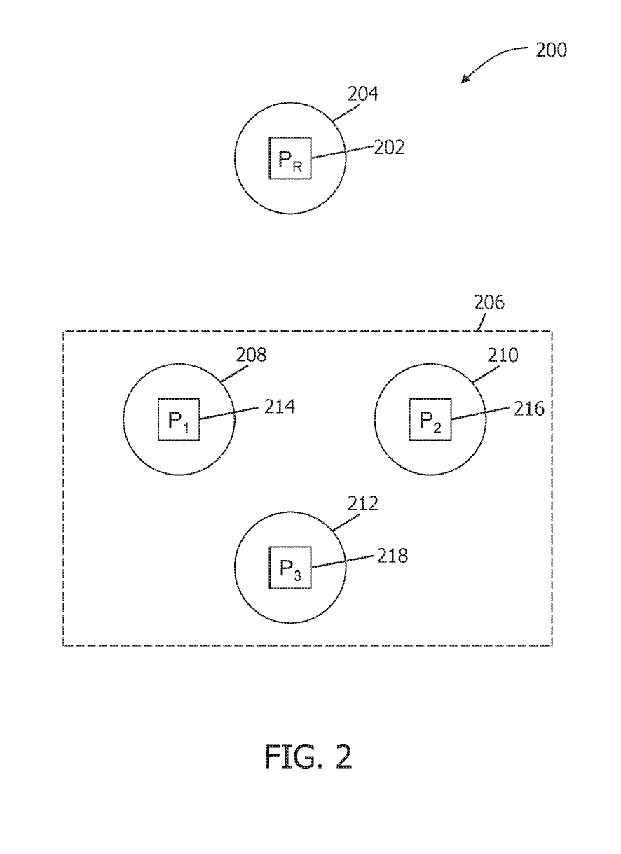

FIG. 2 is a geographic representation 200 of a relocation community recommendation for the system shown in FIG. 1.

Consider a requesting person indicated by P_{R} and 202 referred to hereinafter as “the requestor” that desires to relocate his or her residence to another community but has not specifically decided where. The relocation community recommendation device 114 (FIG. 1) builds an aggregated demographic spending profile for the requestor 202 based on payment transaction made in or relating to the community 204 in which the requestor 202 resides. The requestor's profile may be built in view of the discussion above and the examples described. As such, the requestor 202 may be currently residing in St. Louis, Mo. but wishes to relocate to New York State.

The requestor 202 submits a request to the relocation community recommendation device 114 for a recommendation of a relocation community by identifying a geographic boundary 206. Following the examples above, the geographic boundary 206 may correspond the boundaries of the state of New York, the northern part of the state of New York, or the greater Albany area in New York State as desired. The selection of the geographic boundary may be made using a menu provided to the requestor 202, via a search box where the requestor may enter the state or zip code, or via a boundary drawn on a map by the requestor 202. The relocation community recommendation services are generally scalable and may operate on geographic areas large and small. The requestor 202 may iteratively run generalized requests for relocation communities and hone in on desirable relocation areas, or may directly enter specific areas for a recommendation.

For example, considering a scenario wherein the requestor 202 may have already identified Albany, N.Y. for relocation, the requestor 202 may seek only a recommendation in the Albany area, and may receive the recommendation for Saratoga Springs in return. The requestor 202 may then turn to discovering available properties or rental opportunities in Saratoga Springs with some assurance that Saratoga Springs offers a similar lifestyle to that reflected in the requestor's profile.

Alternatively to specific, targeted use of the relocation community recommendation device 114 in an area that the requestor 202 has already decided, the requestor 202 living in Missouri may consult the relocation community recommendation device 114 in an exploratory manner to discover desirable relocation communities that the requestor 202 may not have considered or perhaps not even been aware of prior to using the system described. As one example of this type, the requestor 202 may initially select the northeastern United States as the geographic boundary 206 in a request for relocation community recommendation and may be receive a recommended state or states in the northeastern United States that may include New York State. The user may then request a recommendation for a relocation community in New York State as the geographic boundary 206 and receive a recommendation for Albany County, N.Y. The requestor 202 may then request a recommendation for a relocation community in Albany County, N.Y. as the geographic boundary 206 and receive a recommendation for Saratoga Springs. The requestor 202 may then request a recommendation for a relocation community in Saratoga Springs as the geographic boundary 206 and receive a recommendation for a more specific area of Saratoga Springs. The requestor 202 may then turn to discovering available properties or rental opportunities in the identified area(s) of Saratoga Springs with some assurance a similar lifestyle to that reflected in the requestor's profile is available with a likelihood of satisfaction.

In view of the above, and considering the breadth of payment card payment systems for users all over the world, the system is operable to provide relocation community recommendations to the requestor 202 in a foreign country of interest, and as such the requestor 202 may initially input a country (e.g., Canada) as the geographic boundary 206 in making a request. It is recognized, however, that requestor 202 need not reside in a remote community from the geographic boundary 206 input to the relocation community recommendation device 114. For example, the requestor may reside in a community in the greater Albany area in New York State, but nonetheless seek a recommendation for relocation community in the Albany area, and may receive a recommendation for Saratoga Springs.

Once the geographic boundary 206 is input to the relocation community recommendation device 114, the relocation community recommendation device 114 provides a relocation recommendation for one of a plurality of different communities 208, 210, 212 that are within the geographic boundary 206. The relocation community recommendation device 114 does so by building profiles of persons, preferably groups of persons indicated as P₁, P₂ and P₃ and 214, 216, 218 in each of the different communities 208, 210, 212 that can be compared to the requestor's profile. For each of persons P₁, P₂ and P₃, aggregated demographic spending profiles are built as payment transaction data is received, and the profiles of P1, P2 and P3 may be compared to the requestor's profile to assess similarities and differences in lifestyle available in each community.

For example, where the requestor's profile shows recurring transactions at a COSTCO® store as a certain proportion of spending over a predefined time period (e.g., a monthly time period), the relocation community recommendation device 114 may look for other of the persons P₁, P₂ or P₃ having a profile showing a similar proportion spend at a COSTCO® store in the same period. In the example of FIG. 2, if community 208 does not have a COSTCO® store, then persons P1 living in community 208 will likely not have a profile including the proportional spend at COSTCO® and community 208 would likely be dropped from further consideration as a relocation community in favor of a community that has a COSTCO® store.

As another example, where the requestor's profile shows recurring transactions at a grocery store and/or transactions at restaurants as a certain proportion of spending over a predefined time period (e.g., a monthly time period), the relocation community recommendation device 114 may look for other of the persons P₁, P₂ or P₃ having a profile showing a similar proportional spend at a grocery store or restaurants in the same period. In the example of FIG. 2, if community 210 does not have a local grocery store but an abundance of restaurants, then persons P₂ living in community 210 may have profiles that match the requestor when the requestor tends to eat out much more than to cook a meal, and community 210 would likely be dropped from further consideration as a relocation community for a requestor that does not each out much. Alternatively, if community 210 has a local grocery store but not an abundance of restaurants, then persons P₂ living in community 210 may have profiles that match the requestor when the requestor tends cook meals much more often than eating out, and community 210 would likely be dropped from further consideration as a relocation community for a requestor that often chooses eating out over cooking.

As another example, where the requestor's profile shows recurring transactions for private school tuition as a certain proportion of spending over a predefined time period (e.g., a monthly time period), the relocation community recommendation device 114 may look for other of the persons P₁, P₂ or P₃ having a profile showing a similar proportional spend for private school tuition in the same period. In the example of FIG. 2, if community 212 does not have a local private school, then persons P₃ living in community 212 likely will not have profiles that match the requestor, and community 212 would likely be dropped from further consideration as a relocation community for a requestor that does not each out much.

Factors such as those above, including others such as gasoline spending and entertainment expenditures, are considered in combination to find persons with similar profiles in order to make a relocation community recommendation. For example, the requestor's profile may be compared to the profile of persons P₁, P₂ or P₃ in multiple aspects to practically ensure that the recommended relocation community provides a lifestyle compatible with the requestor's profile. For example, the requestor's profile may indicate gasoline purchases as a first proportional amount of monthly spending, private school tuition at a second proportional amount of total spending, grocery store spending at a third proportional amount of total spending, restaurant spending at a fourth proportional amount of total spending, entertainment spending (e.g., movie theater spending, concert tickets, or tickets for a local sports team) at a fifth proportional amount of total spending, a gym membership at a sixth proportional amount of total spending, and recreational spending (e.g., golf course charges, television or Internet charges) at a sixth amount of proportional amount of total spending. If persons P₁, P₂ or P₃ are located having similar profiles and spending patterns in similar proportions, communities can be assessed in much detail for possible recommendation as a relocation community.

The more persons that are identified in each community having similar profiles to the requestor in desired aspects, the greater the confidence level in recommending that community. As such, if more than one group of persons are located in respectively different communities, the community having the greater number of persons with matching profiles can be recommended to the requestor over another community having fewer numbers of persons with matching profiles. Depending on the specificity of the geographic boundary 206 in the request from the requestor, a list of communities can be returned in the recommendation with the communities ranked for the benefit of the requestor. For example, in a scenario in which all three of the communities 208, 210 and 212 are found to have a number of persons having matching profiles to the requestor, the relocation community recommendation device 114 may return all three communities for recommendation with the community having the largest number of matching profiles listed first, the community having the second largest number of matching profiles listed second, and the community having the fewest number of matching profiles listed third. The requestor may receive reports with supporting information for each community for further review by clicking on a community in the list.

In each community, the residence of each person profiled is either known or inferred. The residence of each profiled user may be known from payment account information, other bank records or system enrollment information. The residence of each profiled user may alternatively be inferred from transaction data (e.g., shipment data), the location of merchants that are frequented (e.g., gas stations or grocery stores that may be assumed to be close to home), from location services as transactions are made with a user device including a digital wallet and determining a locus of transactions from which a residence of the user can be deduced or in another manner. As such, the inferred or known residence of each profiled user can be used to identify the community of the users for purposes of the relocation recommendation. Profiled users can be therefor be considered by zip code, county, municipality or subdivision based on their inferred or known residences in order to determine matching profiles to make a relocation community recommendation.

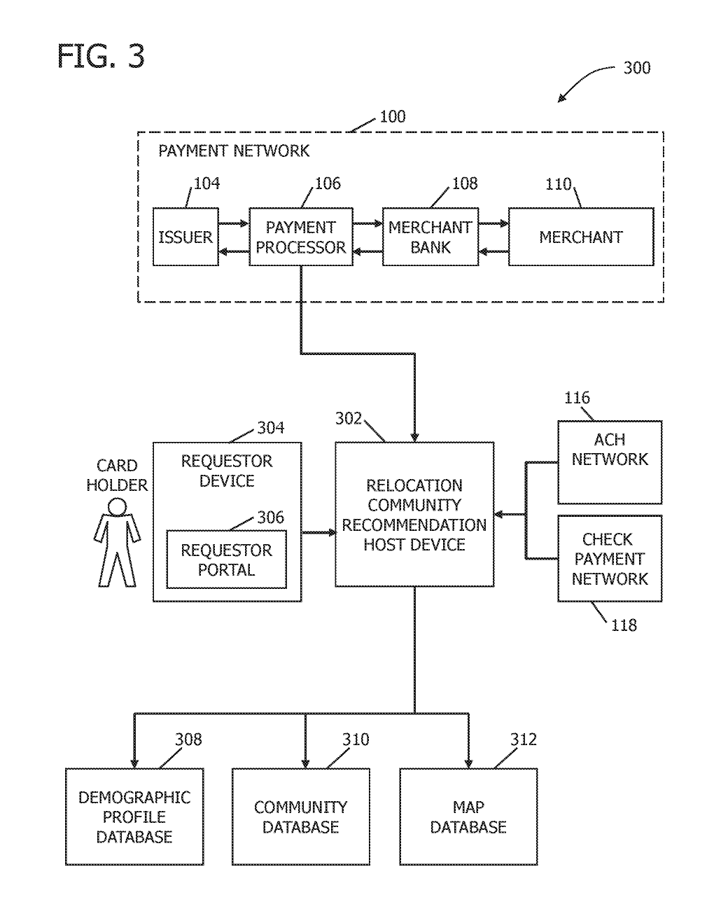

FIG. 3 is an expanded schematic diagram illustrating an exemplary computer system 300 of the disclosure including a relocation community recommendation computing device that operates upon a geographic representation such as that shown in FIG. 2.

The system 300 includes a relocation community recommendation host device 302 in communication with the payment network (FIG. 1) including the issuer 104, payment processor 106, merchant bank 108 and merchant 110. The system 300 accordingly may benefit from transaction data received from the payment network as described below to assist with a relocation community recommendation. Receipt of payment card transaction data from the payment network is considered by the relocation community recommendation host device 302 to build, update and refine aggregated demographic spending profiles in real time as transaction data is received. Issues of stale or outdated payment transaction data are accordingly of no practical concern to the system 300.

The relocation community recommendation host device 302 is also shown in communication with automated clearing house networks and devices 116 and payment check system networks and devices 118. Receipt of payment transaction data from the networks and devices 116 and 118 is also considered by the relocation community recommendation host device 302, in combination with the payment card transaction data, to build and refine aggregated demographic spending profiles in real time as transaction data is received. Issues of stale or outdated data are accordingly of no practical concern to the system 300. The combination of payment data from the different payment card, ACH and check payment systems/networks can be collected and assessed in an automated manner without action by a system user. For example, the relocation community recommendation host device 302 can detect when a payment for private school tuition payment is first made, and add it to the user's profile for consideration in making a relocation community recommendation requested either by that person or by another person that also makes private school tuition payments.

The relocation community recommendation host device 302 is further shown in FIG. 3 in communication with a requestor device 304 at a first location remote from the relocation community recommendation host device 302. Using the requestor device 304, a requestor may communicate with the relocation community recommendation host device 302 via a requestor portal 306 to make a request for relocation community recommendation and receive a recommendation.

The relocation community recommendation host device 302 is further in communication with various databases including a demographic spending profile database 308, a community database 310, and a map database 312. The databases 308, 310, 312 may be local to the relocation community recommendation host device 302 or at respectively different locations from the relocation community recommendation host device 302 in various different embodiments.

A cardholder may use the requestor device 304 and cardholder portal 306 to interact with relocation community recommendation host device 302 and information in the databases 308, 310, 312. The aggregated demographic spending profiles built by the system and parameters used to make them are stored in the database 308 such that once a request for relocation community is made by the requestor, the relocation community recommendation host device 302 retrieves the requestor's profile and compares it to other profiles in the database. Information in the community database 310 is consulted to compare the residences of profiled users to one another in order to make a recommendation and such information may be organized by country, state, county, municipality, zip code or in another manner. Information in the map database 312 may be consulted when the geographic boundary input is provided in a map, and also to display maps of recommended communities for further inspection by a requestor.

Reports may be generated using the information in the database 308, 310 and 312 so that requestors may see their own profiles and supporting data for any relocation community recommendations made or rankings of recommended communities. For example, a requestor may be provided a report including the number of users having matching profiles in each recommended community, a confidence level of the recommendation, and a listing of merchants that relate to the matching profiles. For instance, a community report may include the address of a local COSTCO® store, the names and addresses of private schools in the community, the names and addresses of restaurants and grocery stores, the names and addresses of the nearest movie theater, the names and addresses of local parks and golf courses, the names and addresses of local churches and houses of worship, and other information desired. In contemplated embodiments, the type of information included in the report (or not included in the report) may be selected by the user to meet personal needs and preferences. The relocation community recommendation host device 302 can also use such considerations and user selections as weighting factors to use in building profiles, comparing profiles and making relocation community recommendations.

A cardholder using the requestor device 304 may enroll as a participating cardholder in the relocation community recommendation host device 302. Enrollment may include acceptance of relocation community recommendation service terms, preferred contact information (e.g., email, SMS text notification, push notification, notification via a digital wallet service, etc.) and preferences regarding permission for location services, relocation community recommendation service notifications and the like, or other desired information relating to the cardholder to provide the aggregated demographic profiles and associated relocation community services described.

In contemplated embodiments, the enrollment of cardholders includes opt-in informed consent of users to data usage by the system consistent with consumer protection laws and privacy regulations. In some embodiments, the enrollment data and/or other collected data may be anonymized and/or aggregated prior to receipt such that no personally identifiable information (PII) is received. In other embodiments, the system may be configured to receive enrollment data and/or other collected data that is not yet anonymized and/or aggregated, and thus may be configured to anonymize and aggregate the data. In such embodiments, any PII received by the system is received and processed in an encrypted format, or is received with the consent of the individual with which the PII is associated. In situations in which the systems discussed herein collect personal information about individuals, or may make use of such personal information, the individuals may be provided with an opportunity to control whether such information is collected or to control whether and/or how such information is used. In addition, certain data may be processed in one or more ways before it is stored or used, so that personally identifiable information is removed.

The requestor enrollment may include payment card information, ACH account information and checking account information and permission for the use of ACH data and check payment data. The requestor enrollment may also include acceptance and preferences regarding relocation community recommendation services. The service provided by the relocation community recommendation host device 302 is contemplated as an opt-in service such that only specifically enrolled users may experience such services. Permission to utilize location services in the requestor device 304 may be obtained as part of the enrollment process. Such opt-in consent may be made in any manner desired and accepted by the relocation community recommendation host device 302.

In some embodiments, the opt-in consent may be made through a digital wallet service or application residing on the requestor device 304, and a digital wallet service may provide the requestor portal 306, which may also provide access to payment card account information to allow the cardholder to check payment card transaction activity, review account balances, review payment history, dispute charges, etc. or alternatively may be a unique portal specific to the relocation community recommendation host device 302. More than one requestor or cardholder portal 306 is possible, however, using different devices of the cardholder.

Once a cardholder is enrolled, cardholder information is stored in the demographic profile database 308. As payment card transactions are made and processed by the payment network 100, the relocation community recommendation host device 302 can retrieve information from demographic profile database 308 in order to identify a payment card transaction made by an enrolled cardholder to build or update an aggregated demographic spending profile. For example, the relocation community recommendation host device 302 may compare a primary account number (PAN) of a payment card transaction from, for example, the payment processor 106 in the payment network (FIG. 1) as a payment card transaction is completed to see if it corresponds to the PAN of an enrolled cardholder in order to make such a determination. Preferences and cardholder profile information may also be retrieved for purposes of notice generation (or lack thereof) by the relocation community recommendation host device 302. Notices or alerts to cardholder users generated by the system may be active (e.g., a push notification that activates the user device for possible response) or passive (e.g., email) in nature.

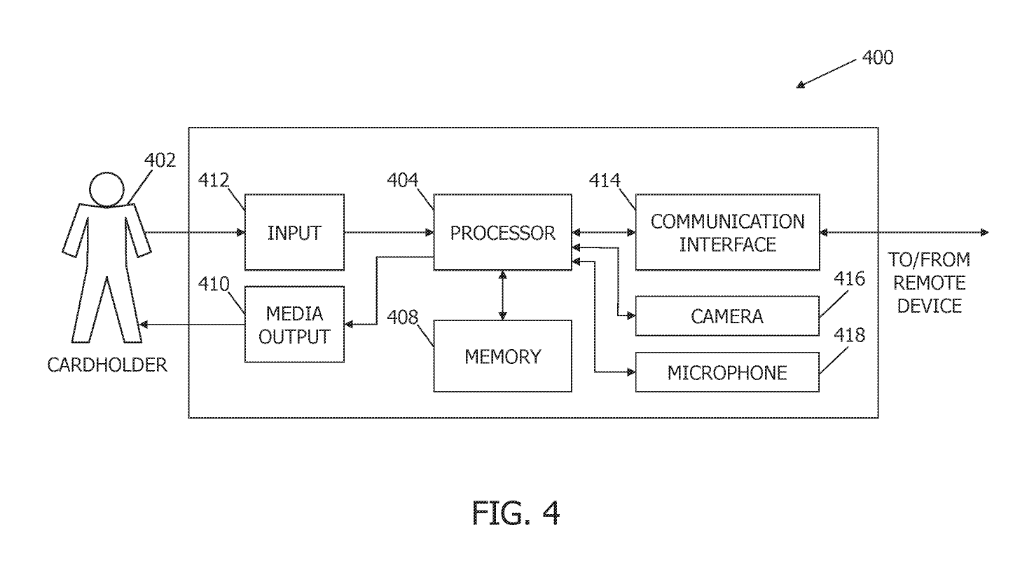

FIG. 4 illustrates an example configuration of a user device 400 operated by a user 402, such as any of the parties described above. User device 400 may include, but is not limited to, a smart phone, a tablet, a notebook or laptop computer, a desktop computer, and a website. In the example embodiment, device 400 includes a processor 404 for executing instructions. In some embodiments, executable instructions are stored in a memory area 408. Processor 404 may include one or more processing units, for example, a multi-core configuration. Memory area 408 is any device allowing information such as executable instructions and/or written works to be stored and retrieved. Memory area 408 may include one or more computer readable media.

The device 400 may also include at least one media output component 410 for presenting information to user 402. Media output component 410 is any component capable of conveying information to user 402. In some embodiments, media output component 410 includes an output adapter such as a video adapter and/or an audio adapter. An output adapter is operatively coupled to processor 404 and operatively couplable to an output device such as a display device, a liquid crystal display (LCD), organic light emitting diode (OLED) display, or “electronic ink” display, or an audio output device, a speaker or headphones.

In some embodiments, the device 400 includes an input device 412 for receiving input from user 402. Input device 412 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 410 and input device 412. The device 400 may also include a communication interface 414, which is communicatively couplable to a remote device in the card payment system network or with other remote devices via networks other than the payment system. Communication interface 414 may include, for example, a wired or wireless network adapter or a wireless data transceiver for use with a mobile phone network, Global System for Mobile communications (GSM), 3G, or other mobile data network or Worldwide Interoperability for Microwave Access (WIMAX), or an 802.11 wireless network (WLAN). The device also includes a camera 416 and a microphone 418.

Stored in memory area 408 are, for example, computer readable instructions for providing a user interface to user 402 via media output component 410 and, optionally, receiving and processing input from input device 412. A user interface may include, among other possibilities, a web browser and client application. Web browsers enable users, such as user 402, to display and interact with media and other information typically embedded on a web page or a website. An application allows user 402 to interact with a server application from a server system.

Multiple user devices 400 are contemplated and respectively provided for use by cardholders, representatives of the issuer, representatives of the payment processor, representatives of the merchant bank, representatives of an automated clearing house system or network, representatives of a check payment system or network, representatives of merchants, and representatives of the relocation community recommendation host device 302 device to effect the system as shown in FIG. 3. Additional and/or alternative users and user devices may be provided, however, as desired for use with the system.

In a variety of contemplated examples, different combinations of user devices, being the same or different from one another, may be utilized in the system with otherwise similar effect. One or more of the user devices may be a mobile device, such as any mobile device capable of interconnecting to the Internet including a smart phone, personal digital assistant (PDA), a tablet, or other web-based connectable equipment. Alternatively, one or more of the user devices may be a desktop computer or a laptop computer. Each of the user devices may be associated with a different user as described. Each user device may be interconnected to the Internet through a variety of interfaces including a network, such as a local area network (LAN) or a wide area network (WAN), dial-in connections, cable modems and special high-speed ISDN lines.

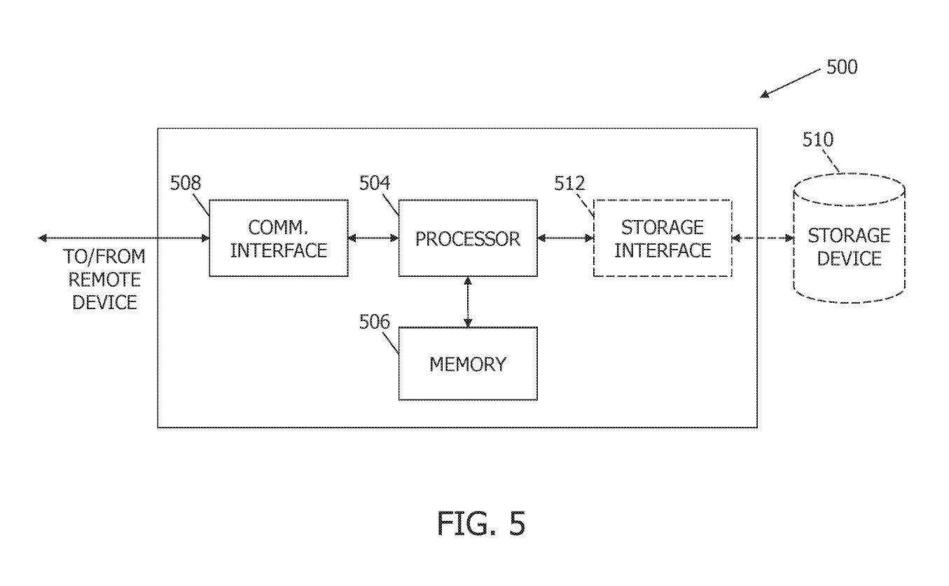

FIG. 5 illustrates an example configuration of a relocation community recommendation computing device 500 that confers the relocation community recommendation services described above. The computing device 500 is sometimes referred to herein as a server-based network “host” device that coordinates and manages the relocation community recommendation services described, although it is not strictly necessary in all embodiments that the host computing device is a server system.

As shown in FIG. 5, the relocation community recommendation computing device 500 includes a processor 504 for executing instructions. Instructions may be stored in a memory area 506, for example. Processor 504 may include one or more processing units (e.g., in a multi-core configuration).

Processor 504 is operatively coupled to a communication interface 508 such that the relocation community recommendation computing device 500 is capable of communicating with a remote device such as a device of the payment network described above, or the requestor device 304.

Processor 504 may also be operatively coupled to a storage device 510. Storage device 510 is any computer-operated hardware suitable for storing and/or retrieving data. In some embodiments, storage device 510 is integrated in the relocation community recommendation computing device 302 500. For example, relocation community recommendation device 500 may include one or more hard disk drives as storage device 510. In other embodiments, storage device 510 is external to relocation community recommendation device 500 and may be accessed by a plurality of server computer devices. For example, storage device 510 may include multiple storage units such as hard disks or solid state disks in a redundant array of inexpensive disks (RAID) configuration. Storage device 510 may include a storage area network (SAN) and/or a network attached storage (NAS) system.

The storage device 510 may include a database server and database which contains information and transaction data for enrolled cardholders, geofence data, map data, or other data needed by the system to operate as described. In one embodiment, the database is centralized and stored on the server system of the relocation recommendation computing device 500. In an alternative embodiment, the database is stored remotely and may be non-centralized.

In some embodiments, processor 504 is operatively coupled to storage device 510 via a storage interface 512. Storage interface 512 is any component capable of providing processor 504 with access to storage device 510. Storage interface 512 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 504 with access to storage device 510.

Memory area 506 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

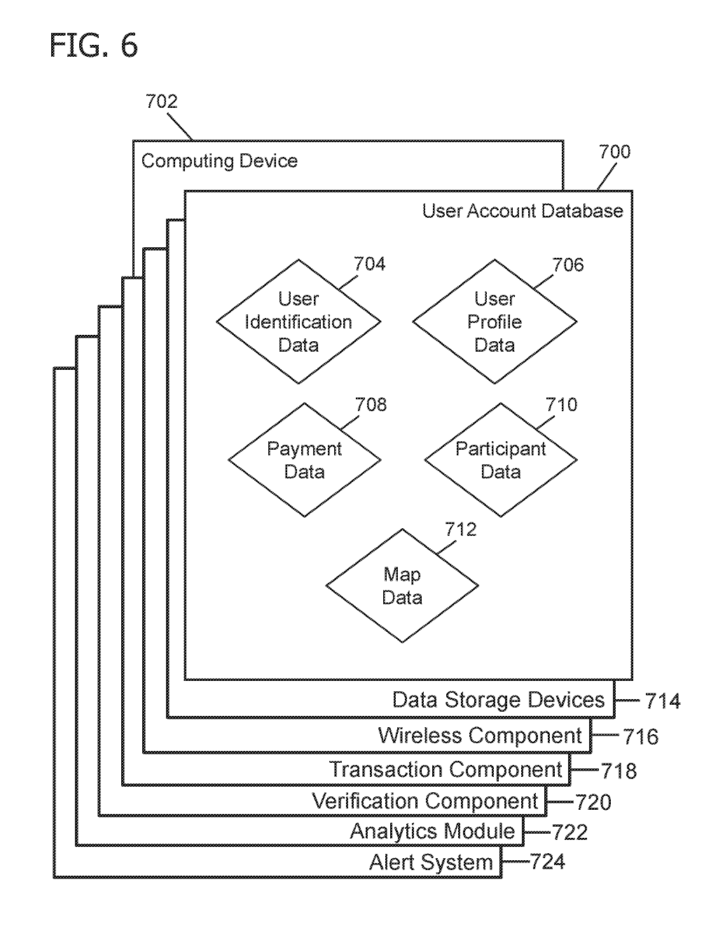

FIG. 6 shows an example configuration of a user account database 700, within a computing device 702, along with other related computing components, that may be used to create, organize, and monitor a plurality of user data associated with a user account. In some embodiments, computing device 702 is the same or similar to the relocation community recommendation server system 500 (FIG. 5). User account database 700 is coupled to several separate components within computing device 702, which perform specific tasks.

In the example embodiment, database 700 includes user identification data 704, user profile data 706, payment data 708, participant data 710, and map data 712. In contemplated embodiments, user identification data 704 includes, but is not limited to, a user name, a user address, and a user phone number. User profile data 706 includes cardholder enrollment data, and other data needed to provide the relocation community recommendation services provided. Payment data 708 includes, but is not limited to, card information, payment history, and a billing address. Participant data 710 includes information associated with participating merchants, including provider identifiers, address information, contact information, etc. Participant data 710 also includes data associated with third party information (e.g., system administrators). Map 10 includes geofence data and location data for accepting input geographic boundaries, determining residence of profiled users, communicating recommended relocation communities to the requestor, and for report generation as described herein.

Computing device 702 includes the database 700, as well as data storage devices 714. Computing device 702 also includes a wireless component 716 and a transaction component 718 for correlating, for example, payment card transactions. An analytics module 722 is included for analyzing transactions, enrollment status, analysis of aggregated transaction data to build the demographic profiles for comparison and relocation community recommendations, and other items of interest. Further included is a verification component 720 that may communicate with a device in the payment network or another device, and an alert system 724 for transmitting an alert to a cardholder or any other party.

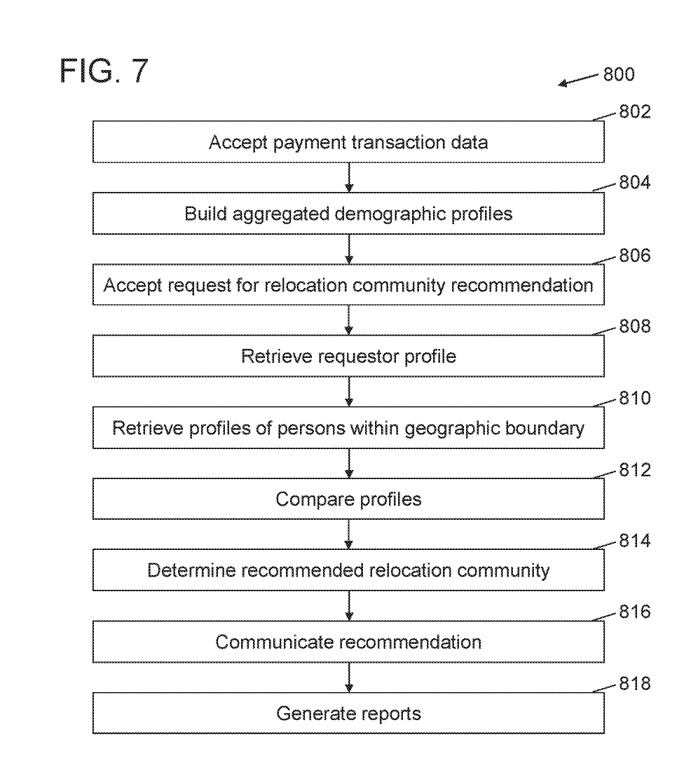

FIG. 7 shows an exemplary process 800 of making a relocation community recommendation for the system 300 (FIG. 3). The process 800 assumes enrollment of users as described above.

At step 802, the relocation community recommendation device accepts payment transaction data relating to a plurality of persons residing in a plurality of communities. As described above, the payment data may include payment card transaction data, ACH transaction data, and payment check transaction data. The payment data may occur more or less in real time as transactions are made, posted or cleared in the respective payment systems as they operate.

At step 804, the relocation community recommendation device, based on the accepted payment transaction data, builds a demographic profile for each of the plurality of persons. Any of the profile techniques described in the examples described above may be adopted for purposes of step 804, although others are possible and may be likewise be utilized in further and/or alternative embodiments. The step of building the profiles includes steps of updating or refining the profiles as needed. For example, if a user obtains a gym membership or begins to make a private school payment, the relocation community recommendation device can automatically adjust or modify the user's profile to include the gym membership or private school payment.

At step 806, the relocation community recommendation device accepts a request for a relocation community recommendation from the requestor. The requestor is one of the plurality of persons having a demographic profile built in step 804. The request for a relocation community recommendation at step 806 includes a geographic boundary as explained above. The geographic boundary may be selected via a drop-down menu, via a boundary drawn on a map by the requestor, via the requestor clicking on a map, via entry of a zip code or area name in a search box, or in another manner as desired.

In response to the accepted request for a relocation community at step 806, the relocation community recommendation device retrieves at step 808 the requestor's profile built at step 804. At step 810 profiles of other persons residing within the geographic boundary are also retrieved. At step 812 the profiles retrieved at steps 808 and 810 are compared to identify persons having matching profiles to the requestor.

At step 814 the relocation community recommendation device determines at least one recommended relocation community within the geographic boundary based on the identified persons having matching profiles to the requestor.

At step 816 the relocation community recommendation device communicates the at least one recommended relocation community to the requestor. The recommendation may include a list of recommended communities, and the list of recommended communities may be ranked based on weighing factors selected by the requestor or the relocation community recommendation device.

At step 818, the relocation community recommendation device generates at least one report for review by the requestor. The report may concern the requestor's own profile or information regarding recommended communities as described above.

The steps 802 through 818 may be performed iteratively as desired by the requestor to obtain more specific results by entering a more specific geographic boundary with the request at step 806. Depending on the number of users profiled in the more specific geographic boundary the recommendation(s) made by the relocation community recommendation device may or may not change. Also, because of the dynamic nature of the payment transaction data received and changes in the number of persons enrolled over time, requests for relocation community recommendations made at different times may return different results by the relocation community recommendation device as it relies on real time data.

At the completion of the process 800, the requestor may turn to locating available properties in a recommended community with some assurance that the recommended community is a good fit for relocation by the requestor.

As will be appreciated based on the foregoing specification, the above-described embodiments of the disclosure may be implemented using computer programming or engineering techniques including computer software, firmware, hardware or any combination or subset thereof, wherein the technical effects described above are achieved. Any such resulting program, having computer-readable code means, may be embodied or provided within one or more computer-readable media, thereby making a computer program product, (i.e., an article of manufacture), according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An electronic computing system for recommending a relocation community, the system comprising:
at least one host computing device comprising at least one processor in communication with a memory device, wherein the at least one host computing device is configured to:
accept payment transaction data relating to a plurality of persons residing in a plurality of communities, and based on the accepted payment transaction data, build a demographic profile for each of the plurality of persons; and
accept a request for a relocation community recommendation from the requestor, the requestor being one of the plurality of persons having a demographic profile and the request for a relocation community recommendation including a geographic boundary; and
in response to the accepted request for a relocation community:
retrieve demographic profiles of persons residing within the geographic boundary;
compare the demographic profile of the requestor to the retrieved demographic profiles of the persons residing within the geographic boundary to identify persons having matching profiles to the requestor;
determine at least one recommended relocation community within the geographic boundary based on the identified persons having matching profiles to the requestor; and
communicate the at least one recommended relocation community to the requestor.

2. The system of claim 1, wherein the at least one host computing device is in communication with a multi-party payment processing network for processing payment card transactions, the at least one host computing device further configured to:
receive payment card transaction data from the multi-party payment processing network; and
build the demographic profile for each of the plurality of persons based on the payment card transaction data.

3. The system of claim 2, wherein the at least one host computing device is in communication with an automated clearing house payment system, the at least one host computing device further configured to:
receive automated clearing house transaction data from the automated clearing house system; and
build the demographic profile for each of the plurality of persons based on a combination of the payment card transaction data the automated clearing house transaction data.

4. The system of claim 2, wherein the at least one host computing device is in communication with a check payment system, the at least one host computing device further configured to:
receive check payment transaction data from the check payment system; and
build the demographic profile for each of the plurality of persons based on a combination of the payment card transaction data and the check payment transaction data.

5. The system of claim 1, wherein the at least one host computing device is in communication with a requestor device, the requestor device including a digital wallet service.

6. The system of claim 1, wherein the at least one host computing device is configured to infer a residence for at least some of the plurality of persons based on the payment transaction data.

7. The system of claim 6, wherein the at least one host computing device is configured to infer a residence for at least some of the plurality of persons based on a locus of a plurality of payment transactions.

8. The system of claim 7, wherein the at least one host computing device is configured to infer a residence for at least some of the plurality of persons based on merchant type and location for a plurality of payment transactions.

9. The system of claim 1, wherein the at least one host computing device is configured to build a demographic profile for each of the plurality of persons based on transactions with a plurality of merchants of a different type and relative transaction amounts with each merchant type as indicated by the transaction data over a defined period.

10. The system of claim 9, wherein the at least one host computing device is configured to build a demographic profile for each of the plurality of persons based on monthly proportional spending across a plurality of different types of merchants.

11. The system of claim 1, wherein the at least one host computing device is configured to generate a report of the requestor's demographic profile for review by the requestor.

12. The system of claim 1, wherein the at least one host computing device is configured to generate a report of the at least one recommended relocation community for review by the requestor.

13. The system of claim 12, wherein the at least one host computing device is configured to generate a ranked list of recommended relocation communities.

14. The system of claim 13, wherein the at least one host computing device is configured to generate a report for a selected one of the ranked list of recommended relocation communities.

15. A computer-implemented method for electronically recommending a relocation community, the computer-implemented method implemented by at least one host computing device including at least one processor in communication with a memory device, the computer-implemented method comprising:
accepting payment transaction data by the host computing device, the payment transaction data relating to a plurality of persons including a requestor with the plurality of persons residing in a plurality of communities, and based on the accepted payment transaction data, building a demographic profile for each of the plurality of persons;
accepting, by the host computing device, a request for a relocation community recommendation from the requestor, the request for a relocation community recommendation including a geographic boundary; and
in response to the accepted request:
retrieving demographic profiles of persons residing within the geographic boundary;
comparing the demographic profile of the requestor to demographic profiles of the persons residing within the geographic boundary to identify persons having matching profiles to the requestor;
determining at least one recommended relocation community within the geographic boundary for the identified persons having matching profiles to the requestor; and
communicating the at least one recommended relocation community to the requestor.

16. The computer-implemented method of claim 15, wherein the at least one host computing device is in communication with a multi-party payment processing network for processing payment card transactions, the computer-implemented method further comprising:
receiving payment card transaction data from the multi-party payment processing network; and
building the demographic profile for each of the plurality of persons based on the payment card transaction data.

17. The computer-implemented method of claim 16, wherein the at least one host computing device is in communication with an automated clearing house system, the computer-implemented method further comprising:
receiving automated clearing house transaction data from the automated clearing house system; and
building the demographic profile for each of the plurality of persons based on a combination of the payment card transaction data the automated clearing house transaction data.

18. The computer-implemented method of claim 16, wherein the at least one host computing device is in communication with a check payment system, the computer-implemented method further comprising:
receiving check payment transaction data from the check payment system; and
building the demographic profile for each of the plurality of persons based on a combination of the payment card transaction data and the check payment transaction data.

19. The computer-implemented method of claim 15, wherein the at least one host computing device is in communication with a requestor device, the requestor device including a digital wallet service, and the computer-implemented method further comprising receiving transaction data from the digital wallet service.

20. The computer-implemented method of claim 15, further comprising inferring a residence for at least some of the plurality of persons based on the payment transaction data.

21. The computer-implemented method of claim 20, wherein inferring a residence for at least some of the plurality of persons comprises inferring a residence based on a locus of a plurality of payment transactions.

22. The computer-implemented method of claim 21, wherein inferring a residence for at least some of the plurality of persons comprises inferring a residence based on merchant types and locations for a plurality of payment transactions.

23. The computer-implemented method of claim 15, wherein building a demographic profile for each of the plurality of persons comprises building a demographic profile based on merchant type and relative transaction amounts as indicated by the transaction data over a defined period.

24. The computer-implemented method of claim 23, wherein building a demographic profile for each of the plurality of persons comprises building a demographic profile based on monthly spending across a plurality of different types of merchants.

25. A non-transitory computer readable medium that includes computer executable instructions for electronically recommending a relocation community, wherein when executed by at least one host computing device having at least one processor in communication with a memory device, the computer executable instructions cause the at least one host computing device to:
accept payment transaction data relating to a plurality of persons including a requestor with the plurality of persons residing in a plurality of communities, and based on the accepted payment transaction data, build a demographic profile for each of the plurality of persons; and
accept a request for a relocation community recommendation from the requestor, the request for a relocation community recommendation including a geographic boundary; and
in response to the accepted request:
retrieve demographic profiles of persons residing within the geographic boundary;
compare the demographic profile of the requestor to demographic profiles of the persons residing within the geographic boundary to identify persons having matching profiles to the requestor;
determine at least one recommended relocation community within the geographic boundary for the identified persons having matching profiles to the requestor; and
communicate the at least one recommended relocation community to the requestor.
